(19) United States
(12) Patent Application Publication
(10) Pub. No.: US 2005/0225501 A1
(43) Pub. Date: Oct. 13, 2005

(54) Self-aligned microlens array for transmissive MEMS image arrray

(76) Inventors: Balakrishnan Srinivasan, Portland, OR (US); Gary F. Shade, Tigard, OR (US)

Correspondence Address: CARRIE A. BOONE, P.C., 2450 LOUISIANA, SUITE 400-310, HOUSTON, TX, 77006, US

(21) Appl. No.: 10/813,255

(22) Filed: Mar. 30, 2004

(51) Int. Cl. G02B 6/26; G02B 6/42

(52) U.S. Cl. 345/32

(57) ABSTRACT

A MEMS optical device includes a MEMS image array and a self-aligned microlens array. The MEMS image array includes a number of individual channels. The microlens array includes individual microlenses, each of which is associated with one of the channels of the MEMS image array. The microlens array is formed directly on the MEMS image array using semiconductor fabrication techniques. Each microlens is automatically aligned with its respective channel within the image array. The need for precise and expensive manual alignment of the MEMS image array and the microlens arrays is avoided. Improvements in the fill factor and the transmission efficiency of the optical device are realized. Further, by tailoring the refractive index of the lens relative to both the substrate and the ambient air, the total internal reflection phenomenon can be exploited, for additional improvement in the transmission efficiency of the optical device.

### FIELD OF THE INVENTION

This invention relates to micro-electrical-mechanical systems (MEMS) and, more particularly, to the use of MEMS systems as part of optical devices such as projection displays.

### BACKGROUND OF THE INVENTION

Micro-electrical-mechanical systems (MEMS), including micro-optical-electro-mechanical systems (MOEMS), are a class of devices utilizing both mechanical and electrical elements, which are integrated on a common substrate. MEMS devices include structures that move mechanically in response to electrical, chemical, pressure, acceleration, vibration, or light signals.

Known particularly for their very small size, MEMS devices are made using techniques familiar to those used in semiconductor fabrication, such as deposition, patterning, and etching. Starting from a material such as silicon, complex features may be disposed upon the substrate in forming the MEMS device. MEMS devices can be made into switches, sensors, actuators, and modulators. Such devices thus have applications in a number of different technology areas, including optical switches, display projectors, automobile airbags, blood analysis devices, inkjet printers, and so on.

In the display arena, MEMS devices represent one of a myriad of microdisplay technologies that are useful both for virtual display and projection display systems. Other microdisplay technologies include active matrix liquid crystal display (AMLCD), high-temperature polysilicon (HTPS), liquid crystal on silicon (LCOS), and digital micromirror devices (DMDs), to name a few. These microdisplays include very small image arrays that may include thousands of individual pixels, or picture elements, for capturing and then displaying an image.

Reflective MEMS image arrays include tiny micromirrors, with each micromirror representing a distinct pixel. The micromirrors are individually controllable by mechanical structures beneath the micromirrors, allowing images to be reflected onto a display or projection screen. Transmissive MEMS image arrays are specialized diffraction gratings, which include tiny slits or holes, one for each pixel. Each hole is individually controllable, so as to be selectively opened or closed in producing the display image.

A virtual display, such as the viewfinder of a digital camera, magnifies the image in the microdisplay. The magnification makes close viewing of the extremely small image possible. Projection systems also magnify the image in the microdisplay, producing an image on a screen suitable for viewing by a large group of people. Whether for virtual display or projection, the imaging device may employ a number of optical elements, such as mirrors, lenses, crystals, prisms, and so on, in transmitting the image.

A MEMS image array may be positioned adjacent to one or more lenses, so as to enlarge the image for viewing. A single lens, about the size of the image array, may be used to magnify the image, for example. Lenses may also be used to improve the fill factor of each pixel in the image array. Fill factor relates to the amount of light processed by each pixel. To improve the fill factor of the pixels, microlens arrays may be part of the MEMS optical system. Microlens arrays include hundreds or thousands of lenses, usually of equal size and shape, arranged into an array. A microlens array positioned adjacent to a MEMS image array may individually magnify each pixel of the image array. Some optical devices used for projection displays, such as transmissive liquid crystal panels, utilize microlens arrays to increase their fill factors.

Typically, a MEMS image array is very small, measuring one inch or less across, for example. The individual pixel regions of the image array are likewise very small, often measured in microns. For a microlens array to be used in conjunction with a MEMS device, each microlens would have to have substantially the same dimension as the pixel element of the MEMS image array. Furthermore, the spacing between the microlenses would have to be substantially identical to the spacing between pixel elements. Otherwise, the arrays would line up at one end, but not at the other end. A misalignment of a lens would produce inaccuracies in the refraction and/or reflection of light, which would, in turn, impair the quality of the final image being displayed.

The use of microlens arrays with MEMS optical devices (and other types of microdisplays) is often not practical for this reason. Indeed, some microlens array manufacturers provide a tolerance figure describing how far offset from an “ideal location” each microlens may be. Where devices such as MEMS image arrays, in which the individual pixels are microns in size, are used, the room for any tolerance is quite small.

Thus, there is a continuing need to provide a mechanism for coupling microlens arrays with MEMS display devices.

### BRIEF DESCRIPTION OF THE DRAWINGS

FIG. 1 is a cross-sectional diagram of a transmissive MEMS image array, according to the prior art;

FIG. 2 is a cross-sectional diagram of the transmissive MEMS image array of FIG. 1, in which individual lenses are positioned adjacent to each channel, according to the prior art;

FIG. 3A is a cross-sectional diagram of a transmissive MEMS image array including a self-aligned microlens array, according to some embodiments;

FIG. 3B is an exploded view of one of the microlenses of FIG. 3A, according to some embodiments;

FIG. 4 is an illustration of the phenomenon of total internal reflection, according to the prior art;

FIGS. 5A-5E are cross-sectional diagrams showing steps for fabricating the transmissive MEMS image array of FIG. 3, according to some embodiments;

FIG. 6 is a flow diagram including steps for fabricating the transmissive MEMS image array of FIG. 3, according to some embodiments;

FIGS. 7A-7D are cross-sectional diagrams showing alternative steps for fabricating the transmissive MEMS image array of FIG. 3, according to some embodiments; and

FIG. 8 is a flow diagram including alternative steps for fabricating the transmissive MEMS image array of FIG. 3, according to some embodiments.

### DETAILED DESCRIPTION

In accordance with the embodiments described herein, a MEMS optical device is disclosed, comprising a MEMS image array enhanced to include a self-aligned microlens array. The MEMS image array includes a number of individual pixel elements, in the form of diffraction grating slits or holes. The microlens array includes a number of individual microlenses, each of which is associated with one of the pixel elements in the MEMS image array. The microlens array is formed on the MEMS image array using semiconductor fabrication techniques, as described in more detail below.

By fabricating the microlens array directly upon the MEMS image array, each microlens is automatically aligned with its respective pixel element within the image array, obviating the need for precise and expensive manual alignment during assembly of the MEMS image and microlens arrays. In some embodiments, improvements in both the fill factor and the transmission efficiency of the optical device are realized. The material used to form the microlens array is selected, in part, to exploit the phenomenon of total internal reflection, which occurs between adjacent media with distinct indexes of refraction. Total internal reflection may further improve the transmission efficiency of the optical device.

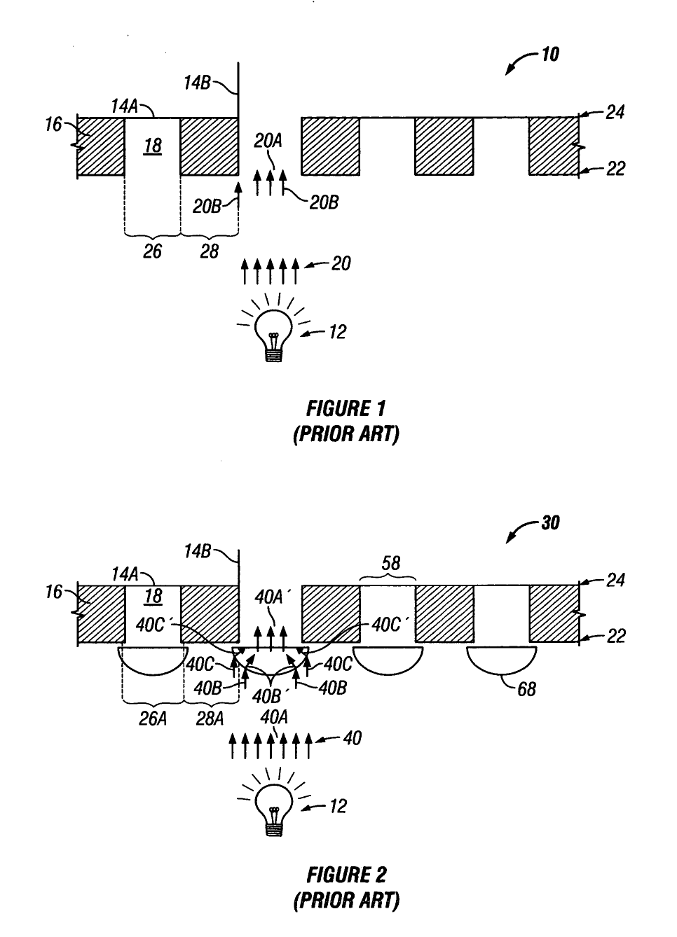

In FIG. 1, a cross-section of a MEMS image array 10 is shown according to the prior art. The MEMS image array is a transmissive diffraction grating, to be used in an optical system such as a microdisplay of a projection system, for example. The MEMS image array 10 is formed on a substrate 16, which may consist of silicon, polysilicon, glass, or other material suitable for fabricating the channels (also know as slits or holes) that make up the diffraction grating.

The MEMS image array 10 includes a plurality of channels 18 arranged in the substrate 16. The channels 18 are voids, typically elongated cylinders or cubes, through which light media may travel. Each channel 18 represents a single pixel of the image array 10. The channel 18 is disposed orthogonal to the substrate 16, extending from a proximal end 22 to a distal end 24 of the image array 10. A light source 12 is disposed at the proximal end 22 of the image array 10.

A plurality of flaps or shutters 14A and 14B (collectively, shutters 14) are disposed along the other end (the distal end 24) of the image array 10. A shutter 14 is allotted for each channel 18. By selectively opening and closing the shutters 14, light is selectively transmitted or not transmitted through the MEMS image array 10. The opening and closing of the shutters 14 is one of the electro-mechanical components of the MEMS device.

The light source 12 supplies light rays 20A and 20B (collectively, light rays 20) to the MEMS device. The light source 12 may be a light bulb, an arc lamp, incident light, or other light media. Light rays 20A enter into the channels 18 of the image array 10. They are either allowed to pass completely through the distal end 24 of the channel 18 by open shutters 14A or are prevented from passing through the distal end of the image array 10 by closed shutters 14A. Light rays 20B make contact with the substrate 16 and may be reflected off the substrate, but do not pass through the channels 18.

The closed shutters 14A thus prevent light rays 20A from passing through the MEMS image array 10. Additionally, the dimension of the channels 18 prevents the light rays 20B from passing through the channels. This selective passage of light rays 20 by the image array 10 is depicted in FIG. 1 using directional arrows.

The channel walls of each channel 18 form a boundary, known herein as the channel boundary 58. In FIG. 1, active pixel and non-active pixel regions are shown. The active pixel region 26 is that region in which light rays are processed (light rays 20A), while the non-active pixel region 28 is that region in which light rays are not processed (light rays 20B). Since the width of the channel 18 determines which light rays are processed, the active pixel region 26 is approximately the width of the channel boundary 58, while the non-active pixel region 28 is approximately the width of the substrate 16.

Before any processing of the MEMS image array 10 occurs, some of the incoming light 20 (e.g., light rays 20B) from the light source 12 are lost. In display technology, the fill factor of an image array refers to the light-gathering capability of the array. The image array may include hundreds or thousands of active pixel regions (such as the channels 18 in FIG. 1) for selectively transmitting the incoming light. The non-active pixel regions of the image array do not transmit the incoming light. The fill factor of an image array indicates the percentage of the light coming to the array that may be processed. Adjustments can be made to maximize the active pixel regions relative to the non-active pixel regions, within limits, since the non-active pixel regions are typically part of the structure of the image array. Further, control structures, such as for operating the shutters 14, may be placed behind the non-active pixel region.

Transmission efficiency is another term used to characterize image media. Transmission efficiency refers to the amount of light that is used by the image array divided by the total amount of light received by the image array. Again, the presence of a non-pixel region in the image array adversely affects its transmission efficiency.

In the hypothetical image array 10 of FIG. 1, not all of the light rays 20 produced by the light source 12 are processed. Of the five light rays depicted in FIG. 1, the three light rays 20A that travel within the channel boundary 58 enter into the channel 18 successfully. Two light rays 20B that travel outside the channel boundary 58 are either reflected off of or are absorbed by the substrate 16. Assuming that the light rays 20A pass completely through the MEMS image array 10 successfully, the image array 10 is thus said to have a transmission efficiency of 60%. CThese numbers are illustrative only and are not meant to describe particular results obtained.) In some image arrays, particularly for microdisplays, lenses are used to improve the fill factor and transmission efficiency of the device. As shown in the enhanced prior art image array 30 of FIG. 2, individual lenses 68 are placed at the proximal end 22 of each channel 18. Light rays, labeled 40A, 40B, and 40C, are produced by the light source 12. The light rays 40A are within the channel boundary 58 and would have entered the channel 18 without the lens 68. The light rays 40B, which are outside the channel boundary 58, are refracted by the lens 68 as light rays 40B′ so that they can enter into the channel 18. The light rays 40C, also transmitting outside the channel boundary 58, are refracted by the lens 68 toward the channel as light rays 40C′, but are blocked by the substrate 16 and, thus, do not enter the channel.

By placing a lens in front of each channel, the size of the active pixel region may be effectively increased. In FIG. 1, the active pixel region 26 is the same size as the channel boundary 58. In FIG. 2, the active pixel region 26A is wider than the channel boundary 58. Likewise, the non-active pixel region is effectively decreased in size. The relative increase in the width of the active pixel region and the simultaneous decrease in the width of the non-active pixel region thus improve the transmission efficiency of the image array 30, as compared to the image array 10. Where the lenses 68 are properly positioned in front of the channels, more transmitted light rays may be processed by the image array 30 than with the lensless image array 10 of FIG. 1.

Some prior art image arrays employ arrays of lenses, also known as microlens arrays, to improve the transmission efficiency of the optical device. The microlens array is positioned between the light source and the proximal end 22 of the image array such that a single microlens is placed in front of each channel (active pixel region). (Microlens arrays may also be used with reflective MEMS devices, such as DMDs, in which the microlens array is disposed in front of each micromirror.)

The use of microlens arrays to improve the transmission efficiency of an image array, while theoretically sensible, is difficult to implement as a practical matter. MEMS devices and other microdisplay technologies are typically custom-manufactured using complex semiconductor fabrication techniques. A microlens array being made for a particular MEMS image array would be custom-produced to exacting standards, so that each lens of the microlens array is properly positioned in front of its respective channel.

Looking at the image array 30 of FIG. 2, if one of the lenses 32 is misaligned from its position adjacent to a channel 18, the desired improvement in transmission efficiency would be lost. Further, an off-centered lens could cause incoming light rays 40 that would otherwise pass through the channel 18 to incorrectly be absorbed or reflected by the substrate 16. Thus, an improperly aligned microlens array could possibly make the image array less efficient than if no microlens array were present.

Further, the size of the active pixel region on a MEMS image array is typically extremely small. A single MEMS image array may include a million pixels in a region less than one-inch square, as one example. The channels of such small image arrays are typically measured in microns. Thus, the size of each active pixel region and the distance between active pixel regions in an image array for a microdisplay are expected to be very small. Thus, a very small error in the alignment of the microlenses with their respective pixel regions may be problematic.

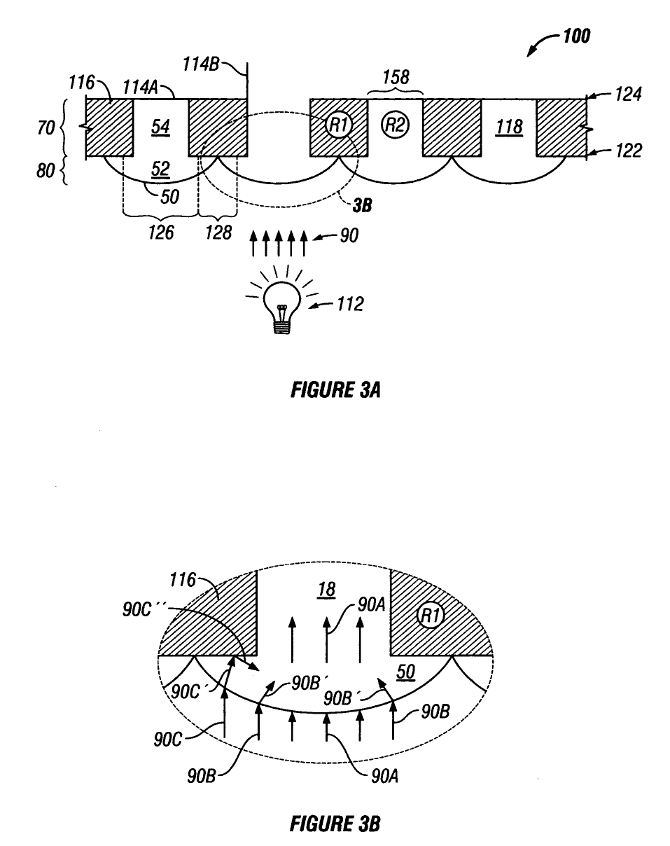

These shortcomings are overcome in a MEMS optical device 100, depicted in FIGS. 3A and 3B, according to some embodiments. The MEMS optical device 100 includes a self-aligning microlens array 80, which is fabricated onto an image array 70, as described below. In some embodiments, the image array 70 is a transmissive diffraction grating. The microlens array 80 includes a plurality of lenses 50, one for each channel 118 of the image array 70. The lenses are composed of a light transmissive material. Polymers and films, such as oxide or nitride films, may have such light transmissive qualities, although many other materials may be suitable for forming the lenses of the microlens array 80.

By forming the microlens array 80 on the MEMS image array 70 directly, the microlens array is self-aligned. That is, each lens 50 that makes up the microlens array 80 is automatically and properly lined up with its respective channel 118 (active pixel region) of the image array 70. In some embodiments, the transmission efficiency of a MEMS image array with a self-aligning microlens array improves from 50% to 80%.

Like the prior art MEMS image arrays 10 (FIG. 1) and 30 (FIG. 2), the image array 70 includes a plurality of channels 118 formed in a substrate 116. Shutters 114 are opened (shutter 114B) or closed (shutter 114A) to selectively transmit or block light media from passing through the image array 70.

A light source 112 produces light rays 90A, 90B, and 90C. Light rays 90A are transmitted within the channel boundary 158. Light rays 90B are transmitted within the active pixel region 126, which is wider than the channel boundary because of the presence of the microlens 50. Light rays 90C are transmitted outside the channel boundary and the active pixel region, in the non-active pixel region 128. as will be shown, the light rays 90A and 90B, as well as some of the light rays 90C, are processed by the image array 70.

A lens 50 is disposed within each channel 118. Each lens 50 includes a head portion 52 and a body portion 54. The body portion 54 of the lens 50 fills the channel 118, approximately to the distal end 124 of the channel at the shutter 114. The head portion 52 of each lens is convex in shape at the proximal end 122. In some embodiments, the shape of the head portion is precisely calculated so as to maximize the processing of light rays coming into the image array 70.

The width of the head portion of each lens extends beyond the active pixel region of each channel 118. In some embodiments, the head portion of one lens ends at approximately the location where the head portion of an adjacent lens begins. By positioning the lenses to extend beyond the active pixel region of each channel, a substantial portion of the light rays 90 received by the image array 70 may be processed.

Light rays 90A, 90B, and 90C are depicted in FIG. 3B, produced by the light source 112. The light rays 90A, which are transmitted within the channel boundary 158, pass through the lens 50 substantially unchanged (although some refraction may occur) and enter into the channel 118. Two light rays 90B transmitted outside the channel boundary 158, but within the active pixel region 126, are refracted by the lens 50 toward the channel as light rays 90B′, and thus enter into the channel 118. (Without the lens 50, the light rays 90B would have contacted the substrate and thus not passed through the channel.) The light rays 90C, which travel outside both the channel boundary 158 and the active pixel region 126, are refracted by the lens 50 toward the channel as light rays 90C′, but are blocked by the substrate 116, and reflected off the substrate as light rays 90C″.

By disposing the lenses 50 within the channels 118 and adjacent to the proximal end 122 of the substrate 116, more light rays 90A are processed by the image array 70 of the MEMS optical device 100 than would be processed without the microlens array 80. Accordingly, the transmission efficiency of the image array 70 is improved with the self-aligned microlens array 80.

The substrate 116 of the image array 70 has a refractive index, R1, which is less than the refractive index, R2, of the lens 50, according to some embodiments. The refractive index is a term used to describe the optical “density” of a material. Refractive index is an indicator of the velocity at which light travels through the material, and also signifies the extent to which a light beam will be deflected when passing through the material. By ensuring that the refractive index of the substrate 16 is less than the refractive index of the lens 50, absorption losses of the light rays 90 into the substrate are minimized, in some embodiments.

Returning to FIG. 3B, the light rays 90C″ may yet enter the channel 118, as the lens material allows a phenomenon, known as total internal reflection, to be exploited. Where light rays pass from a medium of a higher index of refraction to a medium of a lower index of refraction, total internal reflection can be observed for some of those light rays. Light rays that are reflected off the substrate 116 traveling through the lens medium toward the ambient air may qualify for total internal reflection, as the refractive index of the lens medium, R2, is greater than the refractive index of the air, R3. The refractive index of air is approximately 1.00.

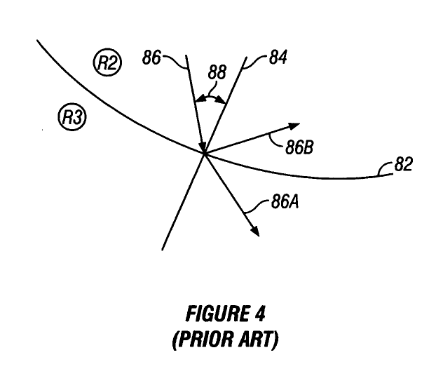

The concept of total internal reflection is illustrated in FIG. 4, according to the prior art. A lens surface 82 is depicted, in which a normal line 84, a line that is perpendicular to the lens at the point of intersection, is drawn. A light ray 86, such as the light ray 90C″, reflected off the substrate 116, is moving toward the lens surface 82. An angle 88 is disposed between the light ray 86 and the normal line 84. Where the angle 88 is less than ie, the light ray 86 is refracted, passing through the lens medium to the air (see light ray 86A). (The chosen angle, iₑ, is based on the refractive index of the two media, and may be calculated using Snell's Law.) Where the angle 88 is equal to or greater than ie, the light ray 86 is reflected (see light ray 86B). In the latter case, the light ray 86 doesn't make it out of the lens material, but is scattered within the lens.

Thus, for at least some of the light rays reflected off and scattered by the substrate 116, the light will not pass through the lens 50, but will be internally reflected, and thus may pass through the channel 118. Thus, the concept of total internal reflection enhances the transmission efficiency of the microlens array-enhanced image array 70, in some embodiments.

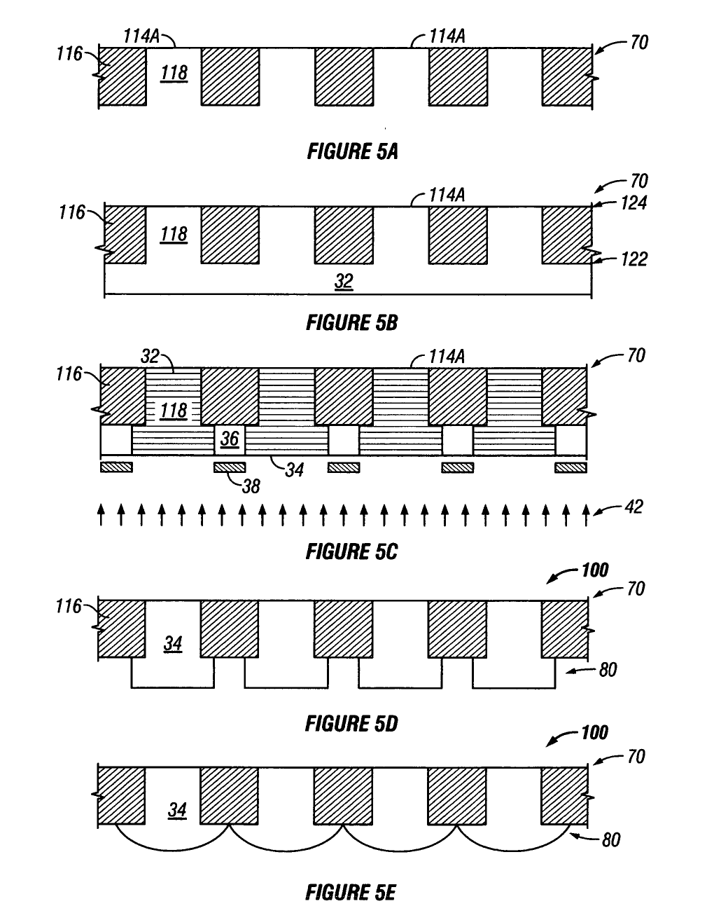

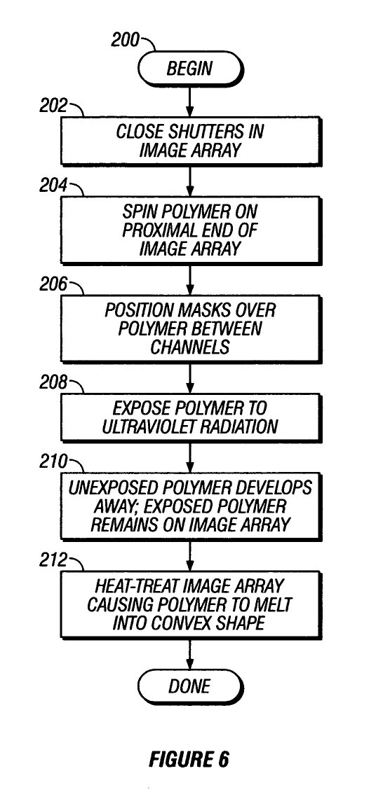

In the illustrations of FIGS. 5A-5E, as well as the flow diagram of FIG. 6, the various steps for producing the MEMS optical device 100 are depicted, according to some embodiments. The transmissive MEMS image array 70 of FIG. 3 is shown, prior to the fabrication of the self-aligned microlens array 80. The MEMS image array 70 includes shutters 114, a substrate 116, and channels 118. All shutters 114 are in a closed position (FIG. 5A and block 202 of FIG. 6).

The image array 70 is subjected to a photosensitive polymer film 32. The polymer 32 is evenly deposited onto the image array 70 at the proximal end 122 (FIG. 5B and block 204 of FIG. 6). The polymer 32, fills the entire space of the channels 118, stopped only by the closed shutters 114 at the distal end 124 of the substrate 116. Further, the polymer 32 extends, or “overflows” outside the channel region, beyond the proximal end 122 of the image array 70. In some embodiments, a spinning technique is used during deposition of the polymer on the image array, in which the centrifugal force of spinning the array causes the polymer 32 to be evenly distributed over the substrate 116 and within the channels 118.

Once the polymer is deposited on the MEMS image array 70, a plurality of masks 38 are positioned in front of the polymer 32 (FIG. 5C and block 206 of FIG. 6). The masks 38 are centered over the substrate portions 116 of the MEMS image array 70, between each channel 118. Next, the polymer 32, which is photosensitive, is exposed to ultraviolet (UV) radiation 42 (block 208 of FIG. 6). The exposure of UV radiation effects a chemical change in the polymer, resulting in two distinct materials, exposed polymer 34 and unexposed polymer 36. One or more solvents may be used to remove the unexposed polymer 36. The unexposed polymer 36 beneath the masks 38 develop away (negative resist), leaving blocks of exposed polymer 34, one for each channel 118, on the MEMS image array 70 (FIG. 5D and block 210 of FIG. 6).

In an alternative embodiment, the mask may be disposed over the channel region, exposed to UV radiation, such that the exposed polymer develops away (positive resist), leaving the unexposed polymer. Semiconductor fabrication designers of ordinary skill in the art recognize a number of techniques for exposing the polymer 32 to produce the polymer blocks 34, as in FIG. 3D.

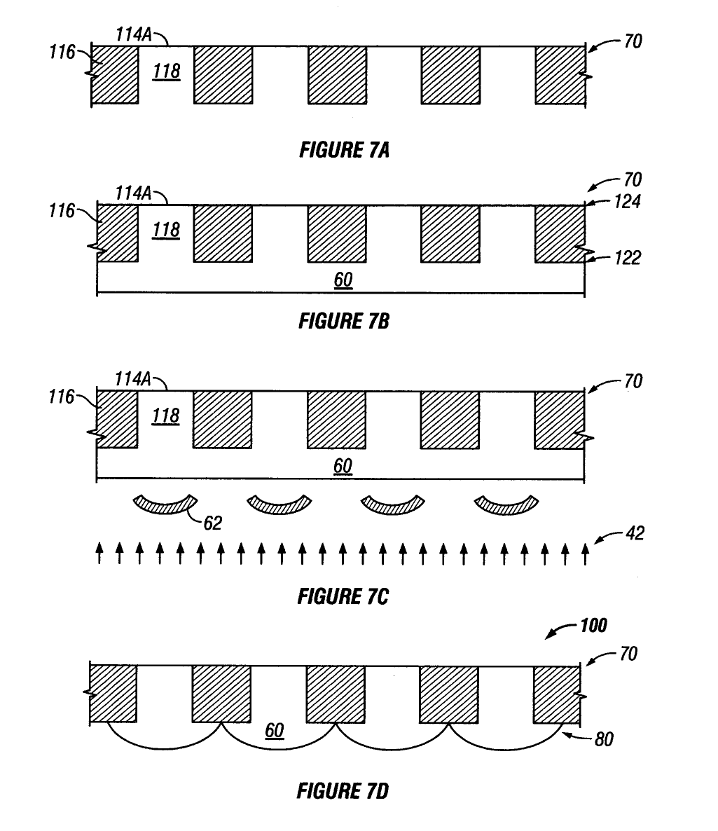

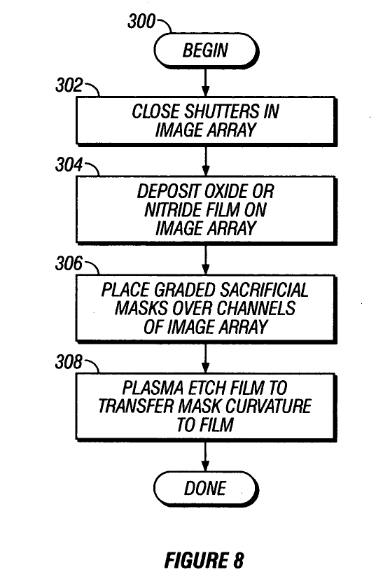

Next, the MEMS image array 70 is exposed to heat treatment (block 212 of FIG. 6). This heat treatment causes the polymer 32 to flow, thus causing each block of polymer to assume a convex shape (FIG. 5E). The polymer is treated for an extended period of time at a high temperature, such that the polymer melts into the convex shape. In some embodiments, the array is heated at 140° C. for 120 seconds. At this point, the image array 70 is coupled with a microlens array 80, forming the MEMS optical device 100 of FIG. 3.

Where further tailoring of the lens shape is desired, an alternate scheme is proposed, according to some embodiments, as illustrated in FIGS. 7A-7D, as also described in the flow diagram of FIG. 8. After the shutters in the MEMS image array are closed (FIG. 7A and block 302 of FIG. 8), an oxide or nitride film 60 is deposited on the MEMS image array 100 (FIG. 7B and block 304 of FIG. 8). In some embodiments, the film is deposited using chemical vapor deposition (CVD) techniques. In one such technique, known as plasma enhanced CVD (PECVD), the substrate is placed in a reactor with a number of gases. When the gases chemically react, a solid material is formed which condenses on the surface of the substrate. Using PECVD, a film 60 of oxide or nitride is deposited, both within the channels 118 and over the substrate 116 of the image array 100. The oxide or nitride film 60 is deposited inside the channels 118, from the distal end 124 of the substrate 116 to beyond the proximal end 122 of the image array 70, as shown in FIG. 7B.

Next, graded sacrificial masks 62 are positioned over the channels 118 of the MEMS image array 70 (FIG. 7C and block 306 of FIG. 8). The sacrificial masks are graded to have a predetermined curvature according to the desired; shape of the microlenses. The underlying oxide or nitride film 60 is then plasma etched to transfer the curvature of the mask into the film (FIG. 7D and block 308 of FIG. 8). Other lithography techniques, such as resist ablation, may be used to transfer the mask curvature to the film. The resulting MEMS optical device 100 includes the image array 70 with the self-aligned microlens array 80.

Whether the polymer 32 or the oxide or nitride film 60 is used, the refractive index of the lens material has a predetermined refractive index, R2. The refractive index, R2, is greater than the refractive index, R1, of the substrate 116. This configuration minimizes absorption losses of the light rays 90 into the substrate.

Further, the refractive index, R2, of the polymer 32 or the nitride film 60 is greater than that of the medium through which the light rays 90 travels, which is typically air. Air has a refractive index close to 1.00. As with the curvature of the lenses, the refractive index is selected so as to maximize the capture of light that is scattered when reflected off the substrate 116 within the lens medium, according to the principle of total internal reflection, in some embodiments.

By fabricating microlenses directly on the MEMS image array 100, the need to manually align a separate microlens array is eliminated. This enhances the yield of an optical device using microlens arrays, that is, the number of good pixels produced during manufacture. A higher yield ultimately lowers the cost of such devices.

Because the head portion 52 of each microlens 50 extends across the channel 118, more light rays can be “captured” for passage through the channel, effectively increasing the width of the active pixel regions 126 in the image array 70. Light ray capture is further enhanced, at least for some light rays scattered by the substrate, by total internal reflection. In some embodiments, the result is a significant increase in the brightness of an image using the MEMS optical device 100.

While the invention has been described with respect to a limited number of embodiments, those skilled in the art will appreciate numerous modifications and variations therefrom. It is intended that the appended claims cover all such modifications and variations as fall within the true spirit and scope of the invention.

1. An optical device, comprising:
a substrate having a plurality of channels therethrough;
a plurality of shutters, with respective shutters associated with respective channels in the substrate; and
a plurality of lenses, each lens having a body portion and a head portion, with respective body portions of the lenses disposed in respective channels of the substrate.

2. The optical device of claim 1, wherein the plurality of lenses comprise a polymer material.

3. The optical device of claim 1, wherein the plurality of lenses comprise an oxide film material.

4. The optical device of claim 1, wherein the plurality of lenses comprise a nitride film material.

5. The optical device of claim 1, the substrate having a first refractive index and the plurality of lenses having a second refractive index, wherein the first refractive index is less than the second refractive index.

6. A method, comprising:
forming a substrate with a plurality of channels therethrough; and
forming a lens array on the substrate with each lens self-aligned with a respective channel in the substrate.

7. The method of claim 6, further comprising:
spinning a polymer on the substrate, wherein the polymer fills the channels and accumulates outside the substrate.

8. The method of claim 7, further comprising:
positioning a plurality of masks over the accumulated polymer, wherein each mask is disposed between channels of the image array; and
exposing the polymer to radiation, producing unexposed polymer and exposed polymer.

9. The method of claim 8, further comprising:
bathing the polymer in a solvent, causing the unexposed polymer to dissolve away.

10. The method of claim 9, further comprising:
heating the exposed polymer until the exposed polymer assumes a convex shape.

11. A method, comprising:
depositing an oxide film on a substrate, the substrate having a plurality of channels, wherein the oxide film fills the plurality of channels from a first end to a second end and accumulates outside the second end of the substrate; and
positioning a plurality of masks over the oxide film, wherein each mask is disposed over one of the plurality of channels, the plurality of masks being graded in a convex shape.

12. The method of claim 11, further comprising:
plasma-etching the oxide film, separating the oxide film into a plurality of oxide film portions, one for each channel, wherein the oxide film portions are substantially convex-shaped.

13. A method, comprising:
depositing a nitride film on an image array, the image array comprising a substrate with a plurality of channels, wherein the nitride film fills the plurality of channels and accumulates outside the image array; and
positioning a plurality of masks over the nitride film, wherein each mask is disposed over one of the plurality of channels, the plurality of masks being graded in a convex shape.

14. The method of claim 13, further comprising:
plasma-etching the nitride film, such that a plurality of nitride film portions remain on the image array, one for each channel, wherein the nitride film portions are substantially convex-shaped.

15. An optical device, comprising:
a diffraction grating, comprising a plurality of channels disposed within a substrate, the channels having a predetermined shape; and
a microlens array, comprising a plurality of microlenses, wherein each microlens comprises a head portion and a body portion, the head portion being convex and the body portion having the predetermined shape, the microlens array being self-aligned with the diffraction grating;
wherein the body portion of each microlens of the plurality of microlenses fits into one of the plurality of channels and the head portion of each microlens of the plurality of microlenses extends outside a second end of the substrate.

16. The optical device of claim 15, wherein the head portion of a first microlens touches the head portion of an adjacent microlens.

17. The optical device of claim 16, wherein the microlens array comprises a polymer material.

18. The optical device of claim 16, wherein the microlens array comprises an oxide film.

19. The optical device of claim 16, wherein the microlens array comprises a nitride film.

20. The optical device of claim 16, wherein the substrate has a first refractive index and the microlenses of the microlens array have a second refractive index and the first refractive index is smaller than the second refractive index.

21. The optical device of claim 20, further comprising:
a light source for sending light rays toward the diffraction grating, to be received by the head portion of each microlens, the light rays comprising first light rays, second light rays, and third light rays;
wherein the first light rays travel within the channel boundary and are received into the channel and the second light rays travel within the active pixel region, but outside the channel boundary, and are refracted by the microlens and received into the channel.

22. The optical device of claim 21, wherein the third light rays travel outside the active pixel region, are refracted by the microlens, but are reflected off the substrate as fourth light rays.

23. The optical device of claim 22, wherein some of the fourth light rays are reflected by the microlens back into the channel according to the principle of total internal reflection.

24. A system, comprising:
a light source; and
an image array positioned to receive light from the light source, wherein the image array includes a self-aligned microlens array formed thereon.

25. The system of claim 24, the image array further comprising a substrate having a plurality of channels formed therethrough, the substrate having a first refractive index.

26. The system of claim 25, the self-aligned microlens array further comprising a plurality of lenses, one for each channel of the image array, each lens having a head portion and a body portion, wherein the body portion completely fills its respective channel.

27. The system of claim 26, wherein the self-aligned microlens array has a second refractive index, wherein the first refractive index is less than the second refractive index.
